(19) United States
(12) Patent Application Publication
(10) Pub. No.: US 2017/0368995 A1
(43) Pub. Date: Dec. 28, 2017

(54) Aerofoil Device

(71) Applicant: SeeClear Limited, Essex (GB)

(72) Inventors: Tim Seeley, Essex (GB); Steven Abbs, Essex (GB); Simon Croft, Essex (GB); Hassan Shirvani, Essex (GB); Jean-luc Mauricette, Essex (GB); Ehsan Koupaei, Essex (GB)

(21) Appl. No.: 15/542,201

(22) PCT Filed: Jan. 5, 2016
(86) PCT No.: PCT/GB2016/050014

§ 371 Date: Jul. 7, 2017

(30) Foreign Application Priority Data
Jan. 8, 2015 (GB) 1500280.1
Mar. 19, 2015 (GB) 1504673.3
Jun. 22, 2015 (GB) 1510970.5

(51) Int. Cl. B60R 1/06; B60S 1/56; B60S 1/54

(52) U.S. Cl. CPC B60R 1/0602; B60S 1/54; B60S 1/56

(57) ABSTRACT

An aerofoil device is provided to aid clearing of a surface, the device comprising a primary arcuate member having an outer curved face and an inner face and a secondary arcuate member, wherein the inner face has a seat portion to receive a clearable surface and the secondary arcuate member is spaced apart from the primary arcuate member and proximal the inner face. The secondary arcuate member comprises at least two spaced apart arcuate elements in a fixed relationship to each other.

### FIELD OF THE INVENTION

This invention relates to an aerofoil device to aid clearing of a surface, in particular transparent and reflective surfaces such as windows and mirrors which need to be kept clear of water or debris.

### BACKGROUND TO THE INVENTION

Windscreens, wing mirrors and other transparent or reflective surfaces need to be kept sufficiently clear to avoid obstructing visibility. Mechanically operated devices such as windscreen wipers, air jets and the like have been proposed to keep such surfaces clear of dirt and/or precipitation. However, there can be a delay whilst mechanical operation takes place, leading to brief periods of reduced visibility. Also, under extreme conditions where there is a lot of precipitation or dust, operation of mechanical devices can become impaired.

Passive air deflectors have been proposed but these are limited in effectiveness and fail to keep the surface sufficiently clear, particularly under extreme conditions.

### SUMMARY OF THE INVENTION

In accordance with one aspect of the invention, there is provided an aerofoil device to aid clearing of a surface, the device comprising a primary arcuate member having an outer curved face and an inner face and a secondary arcuate member, wherein the inner face is configured to receive a clearable surface, such as an externally mounted vehicle mirror, and the secondary arcuate member is spaced apart from the primary arcuate member and proximal the inner face. When the aerofoil device is attached to a vehicle side mirror or the like, movement of the vehicle generates ram air and this air flow which is modified by the arcuate members to produce a laminar air sheet to clear the mirror. Thus in use, the arcuate members create air paths that interact, on the basis of the Coanda effect, to create a laminar sheet of air over the clearable surface, so as to remove precipitation and/or debris such as dust. Such a device is passive and is particularly useful when mounted on a moveable object, such as a vehicle, a helmet visor, or a video recording device attached to an external surface of a car including a lens or imaging screen, as movement generates air flow to create interacting air paths that result in a cleaning laminar air sheet at the clearable surface.

Desirably the laminar sheet is unbroken so that it is complete and uninterrupted with no gaps, and non-turbulent. Thus the laminar sheet may have a contact surface adjoining the clearable surface which is complete and uninterrupted. The laminar sheet may extend across a surface with a contoured profile, such as a concave or convex mirror.

The inner face may further comprise a seat portion for receiving a clearable surface, such as a mirror or a lens or imaging screen.

Preferably the position of the secondary arcuate member is adjustable relative to the primary arcuate member. This allows the secondary arcuate member to be adjustable relative to a clearable surface so that the secondary arcuate member is desirably arranged to create a laminar flow parallel and across a clearable surface.

The secondary arcuate member preferably comprises a leading edge and a trailing edge, the trailing edge configured to be positionable spaced apart from and at an angle of between −15 degrees to +15 degrees relative to a clearable surface.

Preferably the leading edge is inclined at an angle of between −25 degrees to 25 degrees to a curved outer face of the secondary arcuate member.

The trailing edge may be configured to be positionable substantially parallel to a clearable surface.

Each arcuate member is preferably shaped to act as an aerofoil.

The secondary arcuate member may comprise at least two spaced apart arcuate elements in a fixed relationship to each other so as to generate additional air paths during use and increase the laminar flow across the clearable surface. Each arcuate element is preferably shaped to act as an aerofoil.

The arcuate elements are preferably substantially rectangular and interconnected by struts to maintain a constant spacing of around 5 to 15 mm between the arcuate elements.

The aerofoil device may further comprise an attachment means bearing the secondary arcuate member and connectable to a housing containing a clearable surface, for example a wing-mirror housing, camera lens or imaging screen.

The attachment means may be adjustable to allow for alteration of angle and/or distance of the secondary arcuate member relative to a clearable surface with which the device will be used.

Preferably the secondary arcuate member is proximal a vehicle side of the inner face.

The aerofoil device may further comprise a plurality of apertures capable of dispensing jets of fluid or gas as a laminar sheet over the clearable surface. The apertures are preferably associated with a chamber formed within the primary arcuate member, such that fluid or gas is introduced into the chamber for dispersal through the apertures. Such apertures assist with clearing when the aerofoil device is used on a stationary object or when mounted on a moveable object occasionally travelling at low speeds.

The chamber may be configured to ensure each aperture emits fluid or gas at substantially the same pressure. The chamber may thus taper in cross-section along its length so as to create a plenum chamber for containing the pressurised fluid or gas before dispersal through the apertures.

The apertures may be provided by nozzles with a Shore value between 30 to 80 and if desired, may be in the form of holes or slots, slots providing a broader jet.

Where slots are provided, the slots are preferably between 5 mm and 25 mm in length.

The aerofoil device may be retro-fitted in relation to a clearable surface or may be provided integrally in a housing associated with such a clearable surface, and so for example integrated into a side-mirror or wing-mirror housing.

The aerofoil device is envisaged for use within a variety of different areas, such as in association with mirrors and windows of vehicles, windscreens, and helmets.

In accordance with another aspect of the present invention, there is provided a surface clearing apparatus, particularly to enhance visibility from vehicles by clearing mirrors, comprising an aerofoil device as aforesaid.

The apparatus may further comprise an actuation means, such as an electric solenoid, operable by a user, such as a vehicle driver, to emit fluid, or gas, such as compressed air, from the apertures when required.

The apparatus may further be connected to a fluid or gas supply, such as a compressed air supply of a vehicle, and comprise a valve means operable to release fluid or gas through the apertures positioned along the leading edge.

The invention will now be described, by way of example, and with reference to the accompanying drawings in which:

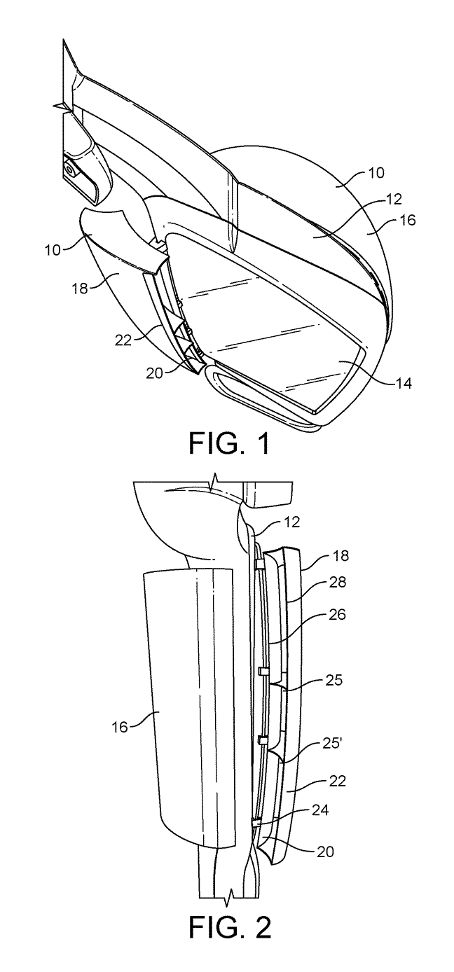

FIG. 1 is a perspective view from above of a vehicle side mirror modified with an aerofoil device embodying the invention;

FIG. 2 shows a side view of the aerofoil device as attached to a vehicle side mirror;

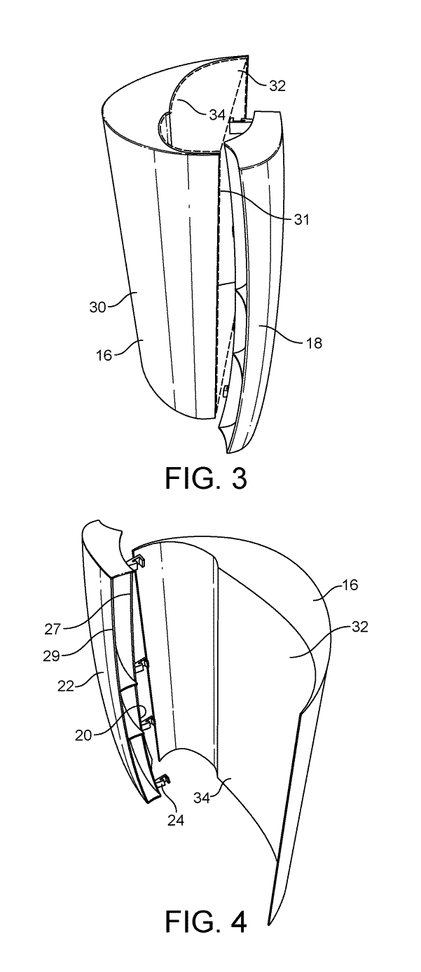

FIG. 3 shows a perspective view from one side of the elements forming the aerofoil device;

FIG. 4 shows a perspective view from the other side;

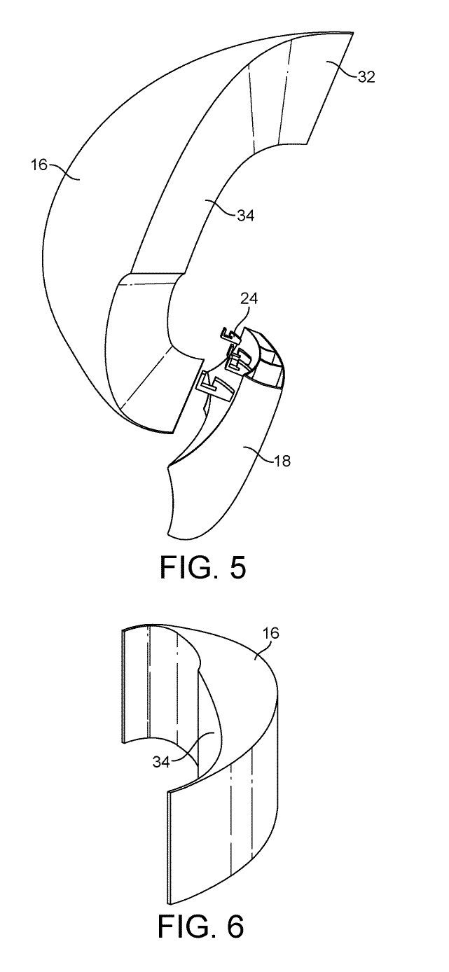

FIG. 5 shows a view from above of the elements forming the aerofoil device;

FIG. 6 shows a perspective view from one side of one element of the aerofoil device;

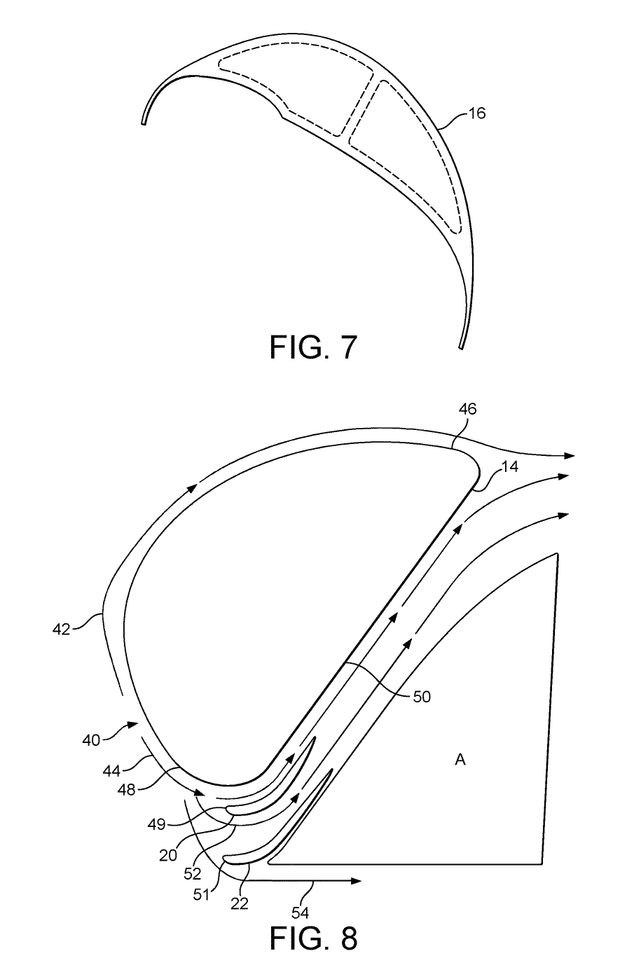

FIG. 7 shows a horizontal cross-section through the element shown in FIG. 6;

FIG. 8 shows an explanatory diagram illustrating air pathways;

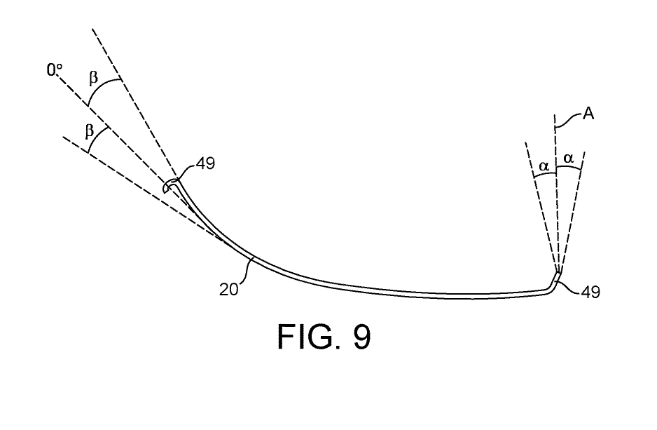

FIG. 9 shows an enlarged side view of one aerofoil surface;

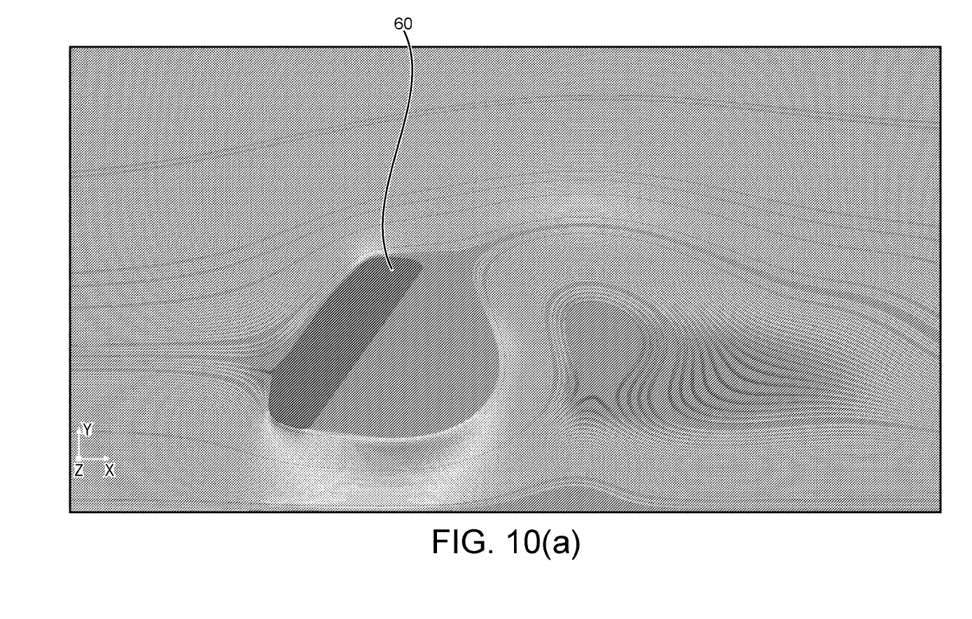

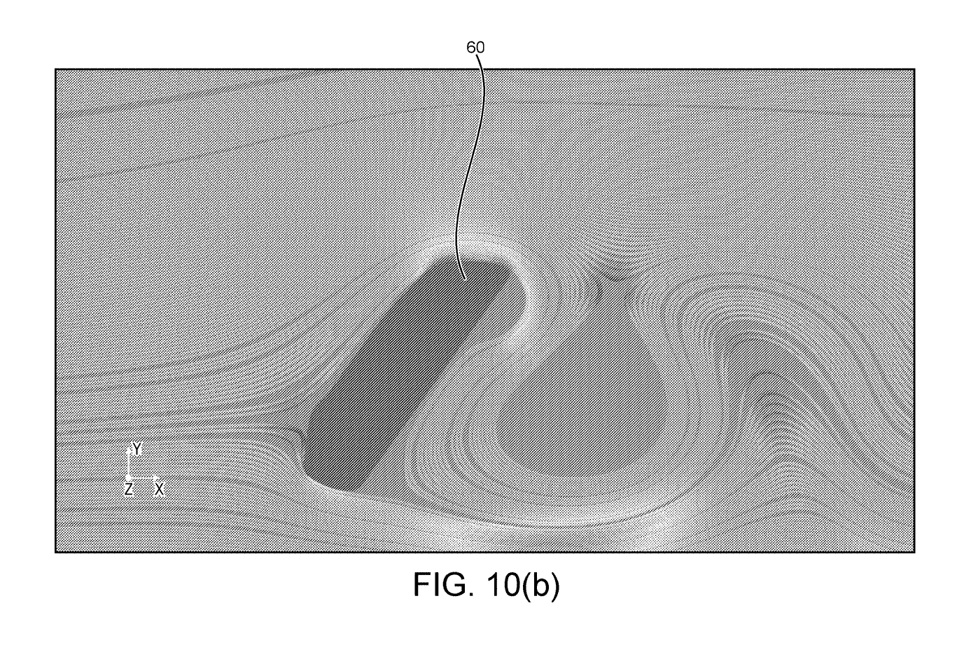

FIGS. 10(a) and (b) show a computer modelling simulation for a prior art wing mirror illustrating airflow relative to a side mirror at different times; and

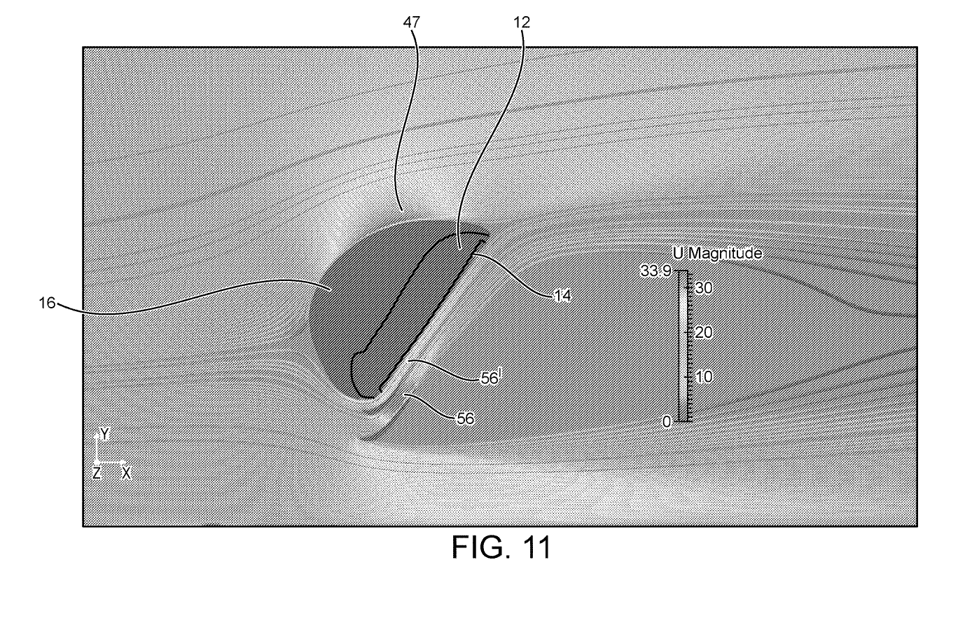

FIG. 11 shows a computer modelling simulation illustrating airflow relative to a side mirror modified with the aerofoil device.

### DESCRIPTION

FIG. 1 shows an aerofoil device 10 attached to a vehicle side mirror housing 12, with housing 12 attached to a vehicle (not shown) such that mirror 14 carried by housing 12 is visible to a driver. Aerofoil device 10 comprises a primary aerofoil structure being a curved aerofoil body 16 and a secondary aerofoil structure 18 attached to the driver's side of mirror housing 12 and so positioned on the driver's side of housing 12 closest to a vehicle. Aerofoil structure 18 is moulded from plastics material and comprises two elongate aerofoils 20, 22 moulded in a parallel fixed relationship to each other. Both aerofoil structures 16, 18 extend the height of a main mirror within housing 12 and are shaped to produce differential air flow over their surfaces. Whilst a retrofitted version of the aerofoil device is illustrated, aerofoil device 10 can be integrated into a wing mirror housing and supplied as a complete mirror and aerofoil unit combined. Whilst two secondary aerofoil structures are shown as an interconnected pair, if desired a single aerofoil can be used instead.

FIG. 2 shows a side view of the mirror aerofoil assembly from the side closest to the vehicle and spaced apart inner and outer secondary aerofoils 20, 22 can be seen. Each secondary aerofoil surface 20, 22 comprises an inner curved face closest to mirror 14 and an outer curved face, with a leading edge and a trailing edge angled towards inner curved face, with both leading edge and trailing edge acting to alter the velocity of air travelling above and beneath aerofoil surfaces 20, 22. For this retrofit version, attachment clips 24 are integrally moulded with secondary aerofoil structure 18 to allow for ease of fixing onto mirror housing 12 and ensure inner secondary aerofoil 20 is spaced apart from mirror housing 14 by a small gap 26. The pair of secondary aerofoil structures 20, 22 are spaced apart by a second gap 28, typically between 5 to 15 mm, and maintained at a constant separation by integrally moulded ribs 25, 25′.

To ensure a suitable air gap between aerofoil 20 and mirror surface 14, aerofoil structure 18 is adjustable relative to the mirror surface by virtue of clip attachment 24 to ensure trailing edges 27, 29 of aerofoils 20, 22 are substantially parallel to mirror surface 14. Typically aerofoil 20 is spaced between 5 to 15 mm from mirror housing 12 and positioned so that trailing edge 27, i.e. the vertical edge closest to mirror 14, is proximal the mirror 14. Whilst clip attachments may be used to make these adjustments for a retrofitted model, swivel joints or the like may be used for an integrally moulded version of a composite aerofoil and mirror housing. Thus to ensure a suitable air gap beneath aerofoil 20, a pivotally adjustable arm can be associated with aerofoil structure 18 to ensure inner surface of aerofoil 20 is spaced between 5 to 15 mm from mirror surface 14 and positioned so that trailing edge 27 is substantially parallel to mirror 14. FIG. 9 shows an example of how the leading and trailing edges can be angled relative to the main aerofoil surface, with only aerofoil 22 shown in side view for ease of explanation. The angle of trailing edges 27, 29 relative to mirror surface 14 can be varied by ±15 degrees from parallel, see FIG. 9 where line A is arranged to be parallel to mirror surface 14. The angle β of leading edges 49, 51 can be varied by ±25 degrees from the curved surface of aerofoils 20, 22, see line B in FIG. 9 which defines zero degrees.

Primary and secondary aerofoil structures 16, 18 can be seen in more detail in FIG. 3 and mirror housing 12 will typically sit within region 31 marked with dashed lines. Outer face 30 of primary aerofoil structure 12 is arcuate in shape with inner face 32 formed to provide a recessed seat 34 in which a mirror housing locates. Additional views are shown in FIGS. 4 to 7.

On forward travel of a vehicle with such an aerofoil attachment, ram air opposing the vehicle motion is incident on the curved surface of aerofoil structure 16 to create multiple air pathways that interact to create a Coanda effect airflow over mirror surface 14, as can be seen by an illustrative example in FIG. 8. Ram air 40 incident on aerofoil structure 16 during forward travel of a vehicle is separated into two paths 42, 44, one path 42 passing to the outer side 46 of structure 16, i.e. the side furthest away from the vehicle, and one path 44 to the inner side. The air passing around the outside has a greatly increased velocity due to the configuration of the arcuate surface, and as can be seen with reference to region 47 in FIG. 11.

Air path 44 deflected around the inner side 48 of structure 16 is incident on the leading edges 49, 51 of secondary aerofoil structures 20, 22, with air passing over the inner and outer surfaces at different speeds and, by way of example, splitting into air paths 50, 52, 54 shown, with regions 56, 56′ having increased velocity as shown in red and yellow in FIG. 10. Paths 50 and 52 combine to form an unchanging laminar flow across the surface of mirror 14, directing a laminar sheet of air across mirror surface 14 to clear existing debris and precipitation from the mirror. The resulting laminar air sheet also provides a protective layer over mirror face 14 preventing additional debris or precipitation being deposited. As the laminar air sheet travels across mirror 14, it interacts with outwardly travelling air path 42 associated with aerofoil 16 to be directed away from mirror 14 in a non-turbulent manner, see FIGS. 8 and 10. The redirected airflow creates a region A of stationary air in front of the mirror. Note that the pathways shown are for illustrative and explanatory purposes and not all pathways are shown.

For a mirror associated with an aerofoil device according to the invention and as shown in FIG. 11, the large region of stationary air created in front of the mirror due to the aerofoil structures means there is no air turbulence in front of the mirror and no change with time of the direction of the air patterns, so decreasing drag by 45 percent as compared to a standard mirror housing. This can be seen by looking at the computational models in FIGS. 10(a) and (b) which show a Computational Fluid Dynamics based model illustrating air flow around a prior art mirror housing 60. The speed of air is shown according to a colour-coded scale, see FIG. 11, with low U magnitude representing nearly stationary air and high U magnitude representing faster flowing air. FIGS. 10(a) and (b) represent airflow at closely spaced times and illustrate the chaotic nature of airflow in front of a prior art mirror.

If desired, and as described in related UK application no. 1504673.3 the contents of which are incorporated herein by reference, aerofoil device 10 or a composite housing incorporating both aerofoil device 10 and mirror housing 12 can include a chamber formed with a plurality of elongate apertures or slots such that the chamber can be connected to a source of compressed gas, such as air, or liquid and be operable by a user to produce jets as and when required. Typically jets will only be required for vehicle speeds below 15 km/h where the clearing effect from aerofoil device 10 requires extra assistance to remove debris and precipitation.

The chamber can be tapered in cross-section along its length to provide a plenum chamber and ensure each slot emits a gas or liquid jet at substantially the same pressure as the other slots. Depending on the mirror length, different numbers of slots can be used, typically between two and twenty slots. A mirror is typically of length 80 to 10 cm and by having a plurality of horizontal jets at an angle of between 10 to 30 degrees relative to the mirror surface, the Coanda effect is created and utilised to clear a larger surface area of the mirror at low speeds when ram air alone is not sufficient to create the Coanda effect at the mirror surface. The mirror can be planar, convex or wide-angled.

Instead of slots, nozzles or circular apertures can be used. Where nozzles are used these will typically be around 1-3 mm in diameter and have a Shore value in the range 30 to 80, arranged at an angle of between 10 to 30 degrees relative to a mirror surface.

A pressurised air supply of between 7 to 9 bar can be routed from an auxiliary air tank fitted to a vehicle and connected into the chamber. An electric air solenoid operable by a driver pressing a switch can open an associated valve to allow air and/or liquid into the chamber and generate jets that produce a laminar air flow at mirror 14. Depending on external conditions, alternating jets of gas and liquid can be produced.

When a vehicle driver experiences inclement weather conditions, such as rain, snow and the like, it is critical that he can see clearly what is behind him in his side-view mirrors. However in such conditions the side window and side mirrors are obscured by rain and spray generated by the vehicle. The present aerofoil device provides a passive device ensuring these surfaces are cleared without driver intervention. The aerofoil device is particularly effective at speeds greater than 15 km/h and if required, compressed jets of gas and/or liquid can provide surface clearing at speeds less than 15 km/h.

1-25. (canceled)

26. An aerofoil device to aid clearing of a surface, the device comprising a primary arcuate member having an outer curved face and an inner face and a secondary arcuate member, wherein the inner face is configured to receive a clearable surface and the secondary arcuate member is spaced apart from the primary arcuate member and proximal the inner face.

27. An aerofoil device according to claim 26, wherein the inner face further comprises a seat portion for receiving a clearable surface.

28. An aerofoil device according to claim 26, wherein the position of the secondary arcuate member is adjustable relative to the primary arcuate member.

29. An aerofoil device according to claim 26, wherein the secondary arcuate member comprises a leading edge and a trailing edge, the trailing edge configured to be positionable spaced apart from and at an angle of between −15 degrees to +15 degrees relative to a clearable surface.

30. An aerofoil device according to claim 29, wherein the trailing edge is configured to be positionable substantially parallel to a clearable surface.

31. An aerofoil device according to claim 29, wherein the leading edge is inclined at an angle of between −25 to 25 degrees relative to an outer curved face of the secondary arcuate member.

32. An aerofoil device according to claim 26, wherein each arcuate member is shaped to act as an aerofoil.

33. An aerofoil device according to claim 26, wherein the secondary arcuate member comprises at least two spaced apart arcuate elements in a fixed relationship to each other.

34. An aerofoil device according to claim 33, wherein each arcuate element is shaped to act as an aerofoil.

35. An aerofoil device according to claim 33, wherein the arcuate elements are substantially rectangular and interconnected by struts to maintain a constant spacing between the arcuate elements.

36. An aerofoil device according to claim 33, wherein the arcuate elements are spaced apart by between 5 to 10 mm.

37. An aerofoil device according to claim 26, wherein in use the interaction of air paths associated with the arcuate members produces a laminar air sheet.

38. An aerofoil device according to claim 26, further comprising an attachment means bearing the secondary arcuate member and connectable to a housing containing a clearable surface.

39. An aerofoil device according to claim 26, wherein the secondary arcuate member is proximal a vehicle side of the inner face.

40. An aerofoil device according to claim 38, wherein the attachment means is adjustable to allow for alteration of angle and/or distance of the secondary arcuate member relative to a clearable surface.

41. An aerofoil device according to claim 26, further comprising a plurality of apertures for dispensing jets of fluid or gas.

42. An aerofoil device according to claim 41, wherein the apertures are associated with a chamber formed within the primary arcuate member.

43. An aerofoil device according to claim 42, wherein the chamber is configured to ensure each aperture emits fluid or gas at substantially the same pressure.

44. An aerofoil device according to claim 43, wherein the chamber has a tapering cross-section along its length.

45. An aerofoil device according to claim 41, wherein the apertures are provided by nozzles with a Shore value between 30 to 80.

46. An aerofoil device according to claim 26 when retrofitted to a side mirror housing.

47. An aerofoil device according to claim 26 when incorporated into a mirror housing for a vehicle.

48. A surface clearing apparatus comprising an aerofoil device as claimed in claim 26.
